(19) United States
(12) Patent Application Publication
(10) Pub. No.: US 2015/0186017 A1
(43) Pub. Date: Jul. 2, 2015

(54) UNLOCKING METHOD AND DEVICE USING TENSION EFFECT

(71) Applicant: Samsung Electronics Co., Ltd., Gyeonggi-do (KR)

(72) Inventor: Jae Myoung LEE, Seoul (KR)

(21) Appl. No.: 14/493,522

(22) Filed: Sep. 23, 2014

(30) Foreign Application Priority Data
Dec. 31, 2013 (KR) 10-2013-0168926

(51) Int. Cl. G06F 3/0484

(52) U.S. Cl. CPC G06F 3/04845; G06F 3/04842

(57) ABSTRACT

An electronic device having a tension effect for unlocking, and method implementing the same are disclosed herein. The electronic device includes a touch panel, and a professor, which are configured to implement the method, which includes displaying an unlock circle centered to the first point on the touch panel when a touch input on a first point of the touch panel is received, and releasing a locked state of the electronic device when the drag input satisfies a pre-specified condition when a drag input is received following the touch input.

### CROSS-REFERENCE TO RELATED APPLICATION

The priority of Korean patent application No. 10-2013-0168926 filed Dec. 31, 2013, the disclosure of which is hereby incorporated in its entirety by reference, is claimed.

### TECHNICAL FIELD

The present disclosure relates to lock screens for portable electronic devices, and, more particularly, to unlocking a lock screen of a portable electronic device using a tension effect.

### BACKGROUND

Electronic devices are generally configured to enter into a locked state if a user input is not received for a predetermined time, or if a user logs off the device. For example, a screen saver may be executed, a monitor may be entered into hibernation, or a screen representing a locked state may be displayed. The user may input a password to unlock the locked state.

Portable electronic devices such as smartphones, tablets, and the like may support the locked state. In the locked state, limited applications such as emergency call, time confirmation, and the like may be allowed. For portable electronic device equipped with a touch screen, the user may sometimes drag a touch input across the screen in a specific direction or input a password to unlock the locked state of the portable electronic device.

As user interface (UI) or user experience (UX) of such an electronic device continue to develop, methodologies for unlocking a locked state are diversifying. For example, to unlock the locked state of a portable electronic device, recognition of user's fingerprint, face, iris, or voice may be utilized in addition to more traditional methods of pre-set gestures and passcodes.

### SUMMARY

The present disclosure allows performance of a fixed operation regardless of user's intention while a gesture or a user input for unlocking is provided.

According to an embodiment of the present disclosure, a method for unlocking an electronic device includes: receiving a touch input on a first point of a screen of the electronic device in a locked state, displaying an unlock graphic enclosing the first point in response to the touch input, receiving a drag input to a second point of the screen, and unlocking the locked state of the electronic device when the drag input satisfies a specified condition.

According to another embodiment of the present disclosure, an electronic device having a tension effect for unlocking includes a touch panel and a processor. The processor may be configured to display an unlock circle centered to the first point on the touch panel when a touch input on a first point of the touch panel is received, and release a locked state of the electronic device when the drag input satisfies a pre-specified condition when a drag input is received following the touch input.

### BRIEF DESCRIPTION OF THE DRAWINGS

FIG. 1 is a view of a guide screen that is displayed in a locked state according to an embodiment of the present disclosure;

FIG. 2 is a view of a screen for unlocking according to an embodiment of the present disclosure;

FIG. 3 is a view of an unlocked screen according to an embodiment of the present disclosure;

FIG. 4 is a view of a screen for unlocking according to another embodiment of the present disclosure;

FIG. 5 is a view of a screen for unlocking according to another embodiment of the present disclosure;

FIG. 6 is a view of a screen for unlocking according to another embodiment of the present disclosure;

FIG. 7 is a view of a screen for unlocking according to a modified embodiment of the present disclosure;

FIG. 8 is a view of a screen for unlocking according to a modified embodiment of the present disclosure;

FIG. 9 is a view of an example structure of an electronic device that supports an unlocking effect according to an embodiment of the present disclosure;

FIG. 10 is a view of an unlocking process of the electronic device according to an embodiment of the present disclosure;

FIG. 11 is a view of an unlocking process of an electronic device according to another embodiment of the present disclosure;

FIG. 12 is a view of an unlocking process of an electronic device according to another embodiment of the present disclosure; and

FIG. 13 is a view of an unlocking process of an electronic device according to another embodiment of the present disclosure.

### DETAILED DESCRIPTION

Hereinafter, embodiments of the present disclosure will be described with reference to the accompanying drawings. Since the present disclosure may have diverse modified embodiments, specific embodiments are illustrated in the drawings and are described in detail. However, this does not limit the present disclosure within specific embodiments and it should be understood that the present disclosure covers all the modifications and/or equivalents and replacements within the idea and technical ambit of the present disclosure. Like reference numerals are used for referring to the same or similar elements in the description and drawings.

The meaning of ‘comprises’ and/or ‘comprising’ specifies a function, an operation, or an element does not exclude other functions, operations or elements. The meaning of ‘include’ or ‘comprise’ specifies a property, a fixed number, a step, an operation, an element, a component, or a combination thereof but does not exclude other properties, fixed numbers, steps, operations, elements, components, combinations thereof

In various embodiments of the present disclosure, the expression “or” or “at least one of A or/and B” includes any and all combinations of words that are listed together with each other. For example, each of “A or B” or “at least one of A or/and B” may include any words (A or B) or all words (A and B).

It will be understood that although the terms “first”, “second”, “firstly” or “secondarily” are used herein to describe various elements, these elements should not be limited by these terms. For example, the terms do not limit an order and/or importance of corresponding elements. The terms used in the description are merely used to distinguish equal or similar items in an ordinal manner. For example, all of a first user device and a second user device may be user devices and also user devices different from each other. For example, a first element referred to as a first element in one embodiment can be referred to as a second element in another embodiment.

It will also be understood that when an element is referred to as being “'connected” to another element, it can be directly connected to the other element or intervening elements may also be present. It will also be understood that when an element is referred to as being “directly connected to” another element, there is no intervening elements.

In the following description, the technical terms are used only for explaining a specific example embodiment while not limiting the present disclosure. The terms of a singular form may include plural forms unless referred to the contrary.

Unless terms used in the present disclosure are defined differently, the terms may be construed as meaning known to those skilled in the art. Terms such as terms that are generally used and have been in dictionaries should be construed as having meanings matched with contextual meanings in the art. In this description, unless defined clearly, terms are not ideally, excessively construed as formal meanings.

An electronic device according to the present disclosure may include a device having a communication function. For example, electronic device may include at least one of smartphones, tablet personal computers (tablet PCs), mobile phones, video phones, e-book readers, desktop personal computers (desktop PCs), laptop personal computers (laptop PCs), netbook computers, personal digital assistants (PDAs), portable multimedia players (PMPs), MP3 players, mobile medical appliances, cameras, or wearable devices (e.g., head-mounted-devices (HMDs) such as electronic glasses, electronic clothes, electronic bracelets, electronic necklaces, electronic appcessories, electronic tattoos, or smartwatches).

According to various embodiments of the present disclosure, the electronic device may be a smart home appliance having a locking or unlocking function. The smart home appliance, for example, may include at least one of televisions, digital video disk (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, or an electric photo-album.

According to various embodiments of the present disclosure, the electronic device may include at least one of various medical appliances (e.g., magnetic resonance angiographies (MRAs), magnetic resonance imagings (MRIs), computed tomographies (CTs), tomographies, ultrasonic waves devices, etc), navigation equipment, global positioning system (GPA) receivers, event data recorders (EDRs), flight data recorders (FDRs), automobile infotainment devices, electronic equipments for ship (e.g., navigation equipment for ship and gyrocompasses), avionics, security devices, head units for vehicle, industrial or household robots, automatic teller's machines (ATMs) of financial institution, or point of sales (POS) of store.

According to various embodiments of the present disclosure, the electronic device may include at least one of a portion of furniture having a locking or unlocking function or buildings/structures, electronic boards, electronic signature receiving devices, projectors, or all sorts of measuring tools (e.g., water, gas, radio gauges, and the like). The electronic device according to the present disclosure may include combinations of at least one of the above-described various devices. Also, the electronic device according to the present disclosure may be a flexible device. Also, it is obvious to a skilled in the art that the electronic device according to the present disclosure is not limited to the above-described devices.

Hereinafter, various embodiments of the present disclosure will be described with reference to the accompanying drawings. The term “a user” that is used in the various embodiments may be referred to a person using the electronic device or a device (e.g., artificial intelligence electronic device) using the electronic device.

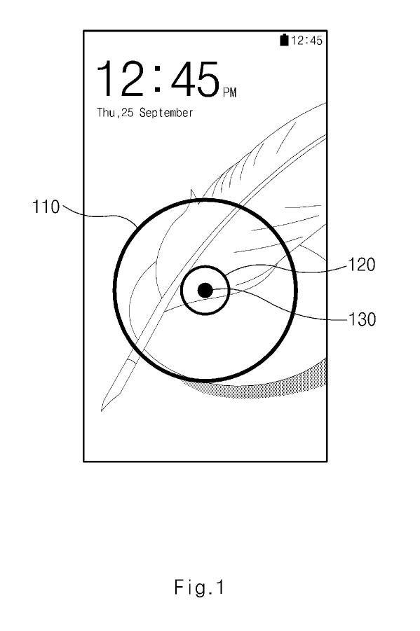

FIG. 1 is a view of a guide screen that is displayed in a locked state according to an embodiment of the present disclosure.

Referring to FIG. 1, a guide screen may include at least one visually displayed object or graphic, such as, e.g., an unlock circle 110, a guide circle 120 corresponding to a present input point that is touched by a user to inform whether an electronic device is unlocked, or a center circle 130 corresponding to a center of the unlock circle 110 to form a concentric circle with the unlock circle 110. Although described below, while the guide circle 120 remains in the unlock circle 110, an unlocked state of the electronic device may be maintained. On the other hand, when the guide circle 120 is moved to the outside of the unlock circle 110 (according to, for example, a touch input), the unlocked state of the electronic device may be released.

The guide screen may be displayed when the user activates a specific key or button in a state where the screen of the electronic device is turned off. For example, when the user presses a “home” key on the electronic device, the guide screen may be displayed for about 0.5 seconds, before fading out gradually to a transparent state. However, since the guide screen is displayed before a user input is performed on the screen, the guide screen may be preset so that the respective centers of all displayed circles are aligned with each other on a predetermined area of the screen. For example, the centers may be aligned respectively according to a predetermined spacing; e.g., in one example embodiment, this would be about 253.7 dpi (dots per inch) from a center portion of the screen or a lower end of the screen. Also, a text guide for unlocking the screen may be displayed on the guide screen; e.g., the character string “swipe screen to unlock” may be displayed in some embodiments.

The unlock circle 110 may provide a guideline with respect to an input for unlocking the electronic device to the user. In more detail, when the user touches one point on the screen of the electronic device that is in the locked state, the unlock circle 110 that is centered to the point may be displayed. In this state (that is, the state where the touch input is maintained, and the unlock circle 110 is displayed), the user may drag the touched point to a predetermined point that is disposed outside the unlock circle 110 to release the locked state of the electronic device. To unlock the electronic device, an additional predetermined condition may be set in addition to the simple dragging of the user to a point that is disposed outside the unlock circle 110. This will be described later. If the drag input is stopped at an inner area of the unlock circle 110 (i.e., meaning the touch input is released while still within the unlock circle 110 after the drag input gesture), the locked state may be maintained.

In various embodiments disclosed in this specification, the user may utilize various input methods. For example, the user may contact the screen (a touch panel) by using his/her finger to provide the user input. Alternatively, the user may contact the screen by using a stylus such as an S-pen to provide the user input or may provide the user input in a non-touch state. In addition to the example input methods, the user input may be realized by using capacitive, resistive, and optical touch methods.

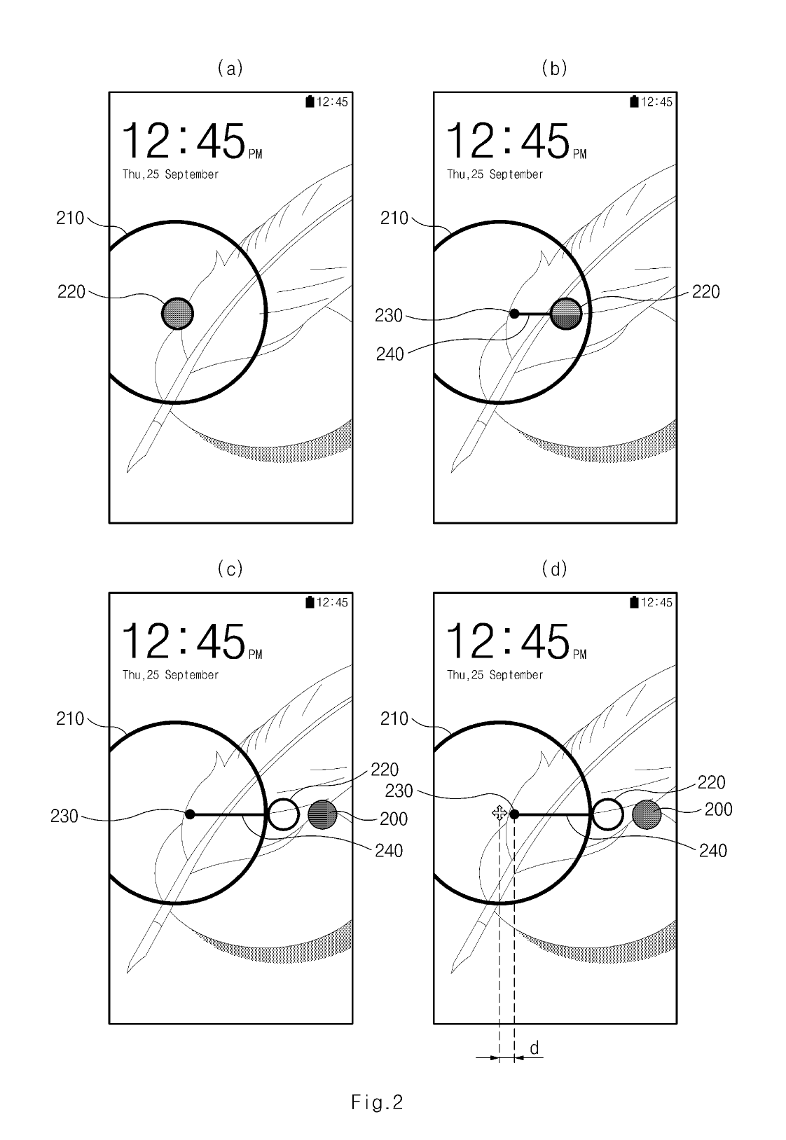

FIG. 2 is a view of a screen for unlocking according to an embodiment of the present disclosure.

FIG. 2A illustrates a screen when the user touches one point on the screen of the electronic device. Referring to FIG. 2A, an unlock circle 210 and a guide circle 220 are displayed, both of which have a center situated according to a user input point. When the user touches the screen of the electronic device, the guide circle 220 may be displayed according to the position of the user input point.

When the user moves the touched point to a specific point within the unlock circle 210 through the drag gesture, a screen illustrated in FIG. 2B may be displayed. In FIG. 2B, a center circle 230 may be displayed, centered to a point that was initially touched by the user. That is, the point that was initially touched by the user may be displayed as the center circle 230, and the point that is touched at present by the user may be displayed as a guide circle 220. The guide circle 220 may move with a slight delay according to movement of the user input. That is, the position of the guide circle 220 and the user input point may correspond to one another even if they are not identically matched with one another at any given moment. However, in various embodiments of the present disclosure, the guide circle 220 may be matched in position with the user input point within the unlock circle 210 after a slight input delay. The center circle 230 may not be fixed in terms of position, but may also be configured to move, as will be described later in this disclosure.

When the user input point is disposed within the unlock circle 210, the guide circle 220 may move according to movement of the user input point. Also, when a boundary of the guide circle 220 is spaced apart from the center circle 230, a line 240 connecting the boundaries of the two circles to one another may be displayed at the shortest distance between the respective boundaries. The guide circle 220 may trace the user input point with a slight time delay difference. For example, if the user drags the user input point from a point A to a point B (not shown) within the unlock circle 210, the guide circle 220 may be followed by the user input to move to the point B. Therefore, the guide circle 220 may have a point corresponding to the user input point. The center circle 230 and the guide circle 220 may be displayed as if the center circle 230 and the guide circle 220 are connected to each other by a connection object, such as, e.g., a ring or line 240, which in turn may be displayed with a simulated amount of tension. That is, a drag input operation by the user may be understood as an operation simulating a physical effect, as if the user pulled the guide circle 220 connected to the center circle 230 by the line 240 having a certain amount of tension. The more the line 240 is pulled, the more the user input point approaches the boundary of the unlock circle 210, and the more tension is applied to the line 240, causing the response to be stronger or more immediate.

This may be reflected in the transparency with respect to the boundary of the unlock circle 210. For example, when one point on the screen that is in the locked state is touched initially, the unlock circle 210 may be displayed as a line having a specific color and transparency of about 80% (e.g., a white line). As the user input point approaches the boundary of the unlock circle 210, the unlock circle 210 may gradually decrease in transparency. As illustrated in FIG. 2C, from the time when the input point 200 is disposed outside the unlock circle 210, the transparency of the unlock circle 210 may be fixed by 0%.

The guide circle 220 may move according to the boundary of the unlock circle 210 from the moment the user input point 200 is disposed outside the unlock circle 210. That is, the corresponding relation between the positions of the guide circle 220 and the user input point 200 may be released. The guide circle 220 is connected to the center circle 230 by a line 240. This connection state may represent a locked state of the electronic device.

To unlock the electronic device, the user may pull the guide circle 220 so that the line 240 exceeds a simulated maximum tension thereof. That is, the user may drag the input point by a predetermined distance or more outward from the boundary of the unlock circle 210. For example, in one embodiment, where the unlock circle 210 has a radius of about 133.2 dpi, when the user input point 200 is dragged from the center of the unlock circle 210 to a point corresponding to about 166.5 dpi (i.e., a point corresponding to about 33.3 dpi from a boundary of the circle 210), the line 240 is displayed as broken, and the electronic device may release the locked state.

Alternatively, the user may drag the user input point 200 to the outside of the unlock circle 210 (i.e., the guide circle 220 is disposed so that a portion thereof contacts the boundary of the unlock circle 210), the input state may be maintained for a predetermined time or more. In this case, the line 240 may also be visually depicted as being broken and the electronic device may thus release the locked state. In this case, the input state may be maintained just by locating the user input point 200 outside the unlock circle 210. That is, it is not always to maintain a state in which the user input point 200 is fixed to one point. The method described in the foregoing paragraph may correspond to a simulation of breaking the line 240 by applying sufficient force to exceed a maximum tension; i.e., the force exceeding an elastic limit. On the other hand, the method described in this paragraph may correspond to breaking durability (or the connected state of the line 240) by maintaining the maximally extending state of the line 240 for a given time.

When the user input point 200 is disposed outside the unlock circle 210, the center circle 230 may move toward the user input point 200. For example, as shown in FIG. 2D, if the user input point 200 moves by a distance D in a right direction from the outside of the unlock circle 210, the center circle 230 may move by a distance d toward the user input point 200. The distance D and the distance d may be a proportional relation, e.g., d=0.2D or something similar therebetween. Alternatively, the distance d may have a fixed value. For example, the center circle 230 may move by a distance d=18.6 dpi toward the user input point 200.

If the user input is finished in the state illustrated in FIG. 2B, the locked state of the electronic device may not be released. “Finishing” the user input may qualify as, for example, a user's hand pulling away from detectable interaction with the screen, activation of a specific button such an end button or a home button, or removal of a stylus or other input tool from the screen. In this case, the guide circle 220 may then increase in radius by about 200% of the initial radius thereof while maintaining the center of the guide circle 220 to increase transparency, thereby allowing the guide circle 220 to enlarge and subsequently fade out. For example, the guide circle 220 may start with a diameter of about 46.9 dpi and then increase in diameter to about 73.9 dpi, the guide circle 220 may then fade out. That is, the displayed circles (i.e., the unlock circle 210 and/or the guide circle 220) may be tarnished or/and dispersed to fade out. Also, a portion of the circles may not be displayed or may be displayed when the user input is executed. Also, the line 240 may fade out while moving to the center circle 230 (i.e., while decreasing in length of the line 240) as if a pulled rubber band returns to it original point when being released. Alternatively, the line 240 may be shortened in a wave form to fade out. Alternatively, the line 240 may increase in transparency without being changed in length or shape to fade out.

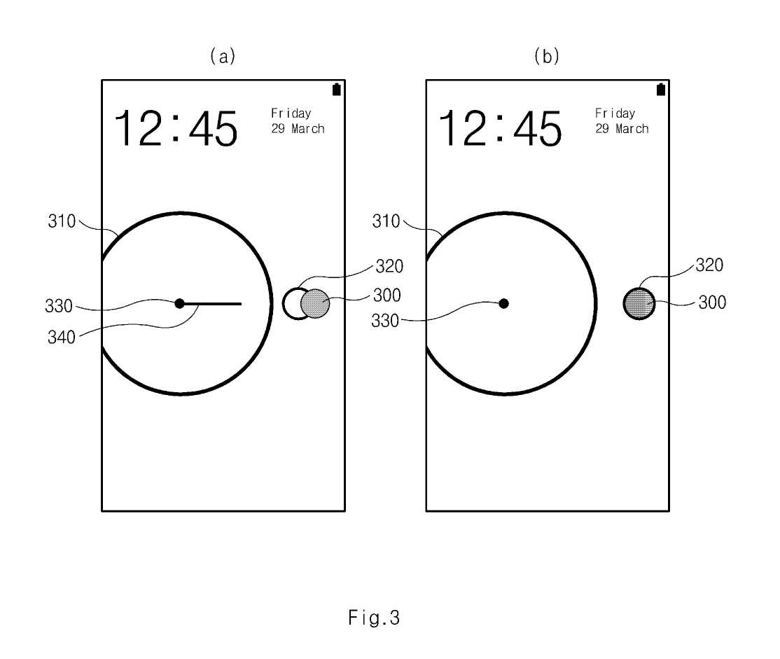

FIG. 3 is a view of an unlocked screen according to an embodiment of the present disclosure.

FIG. 3 illustrates a screen at a time point at which the conditions described in FIG. 2 are satisfied to unlock the electronic device. When the electronic device is unlocked, i.e., when a line 340 connecting a guide circle 320 to a center circle 330 is broken, a guide circle 320 connected (or restrained) to an unlock circle 310 may move to the present user input point 300, and the line 340 may move (or decrease in length) toward the center circle 330. FIG. 3A illustrates one frame that is moving as described above. When the movement is finished, the line 340 may fade out, and a position of the guide circle 320 may be matched with the position of the user input point 300. This state is illustrated in FIG. 3B. After a screen illustrated in FIG. 3B is displayed, the locked state may be released, and a home screen application, application screen or some other screen set to be activated upon unlocking may be displayed.

If the center circle 330 moves by a distance d′ (not shown) from the original position before the line 340 is broken, the center circle 330 may move by the distance D′ in an opposite direction due to the broken line 340. That is, when the line 340 connecting the center circle 330 to the guide circle 320 is broken, the center circle 330 and the guide circle 320 may move in directions opposite to each other. In this case, the moving distance d′ of the center circle 330 and the moving distance D′ of may be a constant proportional relation therebetween.

The descriptions with respect to the unlocking in FIG. 2 may be applied to the example of FIG. 3, and also their duplicated descriptions will be omitted.

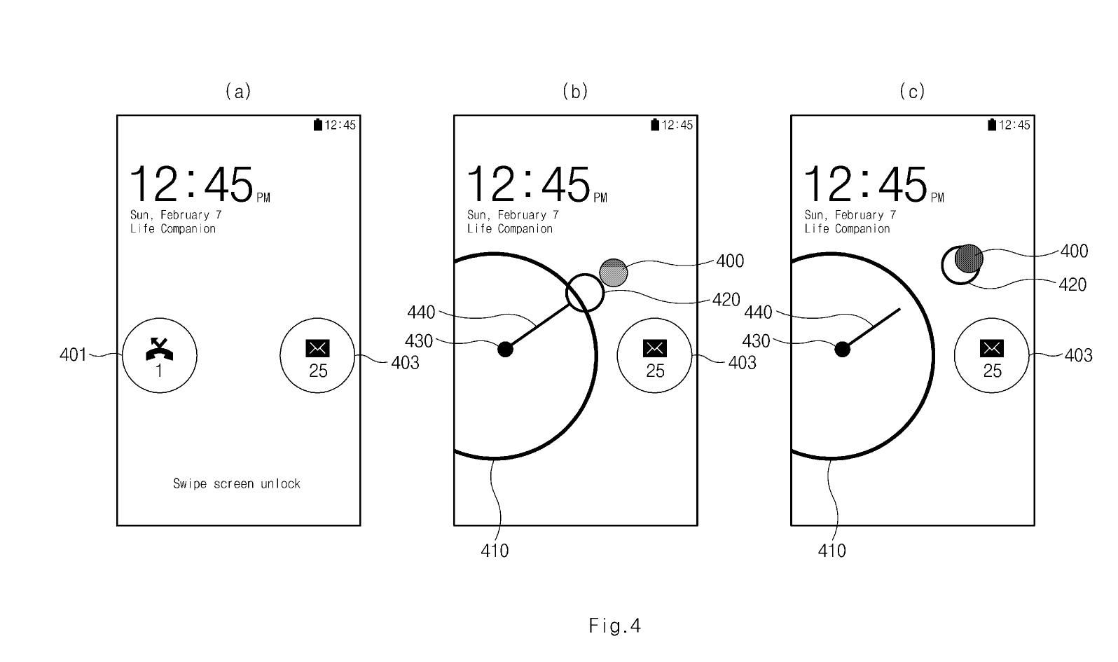

FIG. 4 is a view of a screen for unlocking according to another embodiment of the present disclosure.

The electronic device may display notification icons for events generated by applications, unread messages, missed calls, and other such system events that require notification of the user. Such notifications may be displayed by the electronic device in a locked state. For example, FIG. 4A illustrates a state in which one missed call and 25 text messages are received, and the user has not yet examined the missed call and text messages. In this case, an icon 401 that represents a missed call and an icon 403 that represents a text message may be displayed on a screen of an electronic device. The icons 401 and 403 may be translucently displayed.

When the user selects (touches) the icon 401, an unlock circle 410 may be disposed around the icon 401. As illustrated in FIG. 4B, the user may drag a touch point (a user input point 400) to the outside of the unlock circle 410. In this case, the icon 401 may not be displayed as illustrated in FIG. 4B, or may be displayed with increasing transparency. Similarly, the icon 403 may not be displayed or may be displayed with increasing transparency. If the user input is released in the state illustrated in FIG. 4B, even though an input point may be disposed outside the unlock circle 410, since the predetermined conditions described in FIG. 2 are not satisfied (i.e., since the guide circle 420 and the center circle 430 are connected to each other by a line 440), the locked state may not be released.

Since touch-based screens of many portable electronic devices have an input function as well as a display function, users may mistakenly access notifications. For example, a missed call icon may be accidentally selected when an icon representing a missed call is inadvertently touched and interpreted as a selection command. The user may thus accidentally return a call to a person with which the user does not want to talk, or read/send a message or message confirmation unintentionally. However, according to the embodiment of the present disclosure, even if the informing icon is selected by mistake, if the user does not intentionally release the locked state, an application (for example, a call dialer application or message confirmation application) corresponding the information icon will not be executed.

Instead, to release the lock state and access the corresponding application, the user must continuously drag the touch point to the outside of the unlock circle 410 or maintain the state of FIG. 4B for a predetermined time to cause the line 440 to be broken. Only then will the locked state be released. A screen related to above-described state is illustrated in FIG. 4C. The line 440 may move toward the center circle 430, and the guide circle 420 may move toward the user input point 400. The above-described descriptions with respect to the unlocking may be applied to the example of FIG. 4, and thus their duplicated descriptions will be omitted.

In the embodiment of FIG. 4, when the lock state is released, the call application may be executed to automatically return the missed call, or the call application may be executed to confirm and display information with respect to the missed call. If the icon 403 is selected and dragged to release the locked state, the message application may be executed to confirm the received message.

In the screen illustrated in FIG. 4A, if the user selects any area except for an area corresponding to the icon 401 or 403, the unlock circle may be displayed around the selected area. Then, when the user releases the locked state through the dragging, the unlocked state of the electronic device may be simply released without executing the application corresponding to the icon. Here, a home screen or a screen where a user worked lately may be displayed.

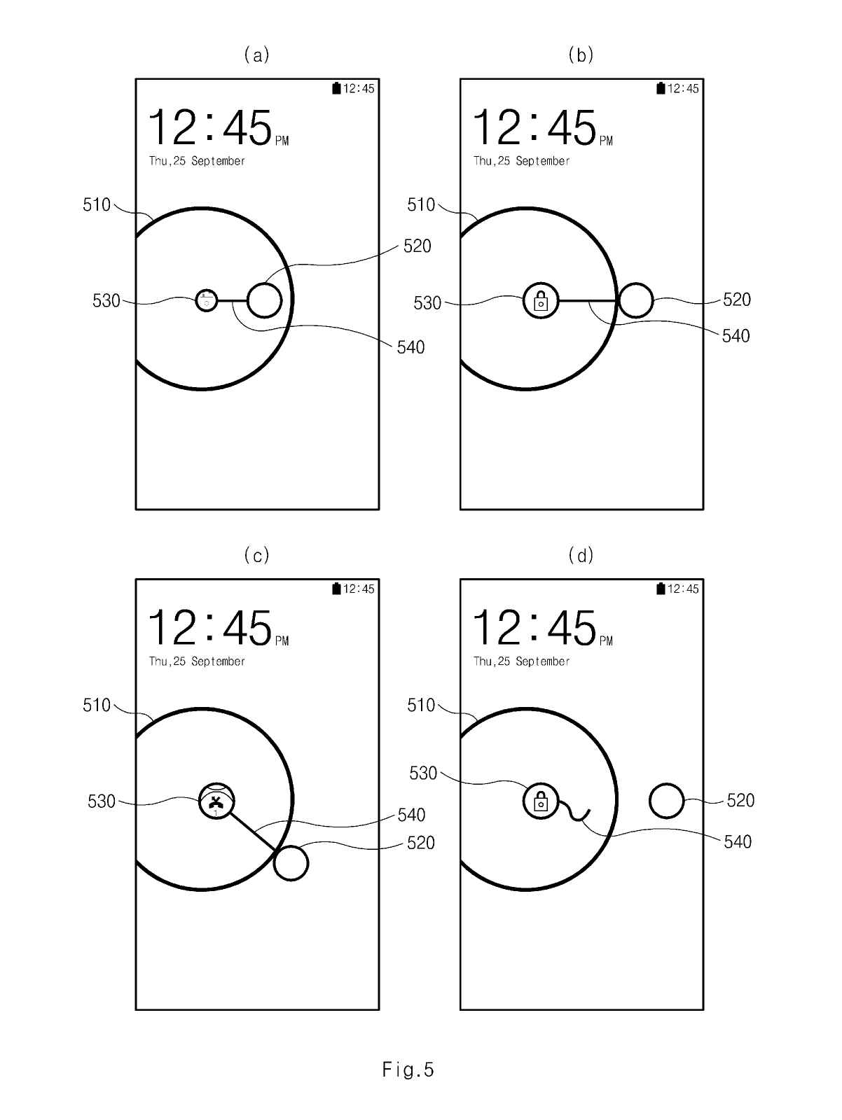

FIG. 5 is a view of a screen for unlocking according to another embodiment of the present disclosure.

Referring to FIG. 5A, as the user input point approaches an unlock circle 510, an event occurring when a locked state is released may be displayed on an area of a center circle 530. For example, an icon 501 displayed when a guide circle 520 is disposed outside the unlock circle 510 as illustrated in FIG. 5B may represent a simple unlocking. When the guide circle 520 is changed in position outside the unlock circle 510, an icon different from the icon 501 may be displayed. For example, when the guide circle 520 moves downward as illustrated in FIG. 5C, an icon 503 that represents a missed call may be displayed. If the guide circle 520 moves upward, an icon (not shown) that represents a camera may be displayed. When a specific icon is displayed on an area of a center circle, if an electronic device is unlocked, an event (or application) corresponding to the specific icon may be executed. As seen in FIG. 5D, when the guide circle 520 is moved away a certain distance from the unlock circle, the unlock icon 530 is shown, and the line 540 (corresponding to line 240 of FIG. 2) may be broken.

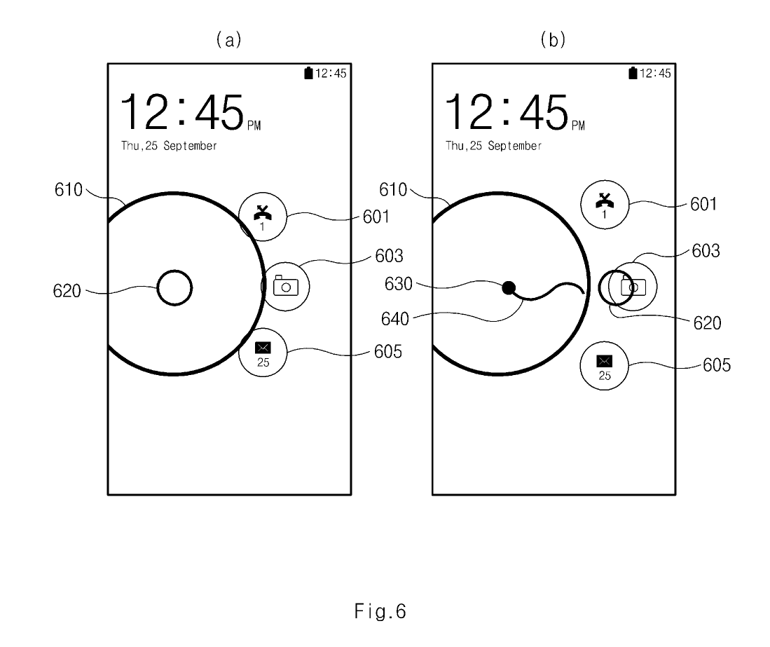

FIG. 6 is a view of a screen for unlocking according to another embodiment of the present disclosure.

Referring to FIG. 6A, when a user touches one point on a screen of an electronic device that is in a locked state, an icon that is capable of being executed together with an unlock circle 610 may be displayed. For example, an icon 601 that represents a missed call, an icon 603 that represents a camera application, and an icon 605 that represents a text message may be displayed. The icons may be displayed as if the icons are spread from a touched point (i.e., a center of the unlock circle 610) toward a point illustrated in FIG. 6A or FIG. 6B. The icons may be displayed opaquely or transparently. The icons may be disposed outside the unlock circle 610.

If a user breaks a line 640 connecting a guide circle 620 to a center circle 630 to release the locked state in a state where the user drags an input point to allow the guide circle 620 to be disposed on the icon 603, the electronic device may be unlocked to execute an event corresponding to the icon 603, such as, for example, the camera application. Alternatively, when the guide circle 620 is disposed on the icon 601, 603, or 605 or approaches a preset distance or less, the guide circle 620 may be fixed to the area of the corresponding icon to execute the corresponding application. In this case, the corresponding appliance may be executed just when being fixed. Alternatively, the corresponding appliance may be executed when the foregoing unlocking conditions are satisfied after being fixed.

If the foregoing predetermined conditions related to the descriptions of FIG. 2 are satisfied after the user drags the touch input to an area that does not correspond to the icon 601, 603, or 605, the locked state may be released, and an additional event may not occur.

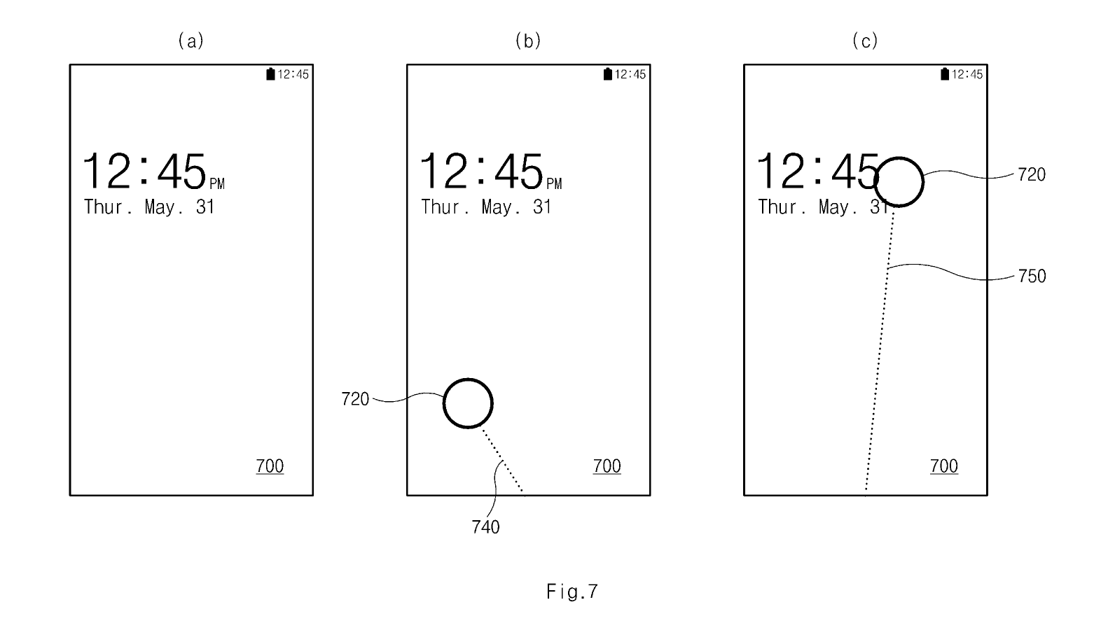

FIG. 7 is a view of a screen for unlocking according to a modified embodiment of the present disclosure.

FIG. 7A illustrates a screen 700 of an electronic device that is in a locked state. When a user drags the screen 700 of the electronic device upward from a lower end of the screen 700, as illustrated in FIG. 7B, a guide circle 720 may be displayed which corresponds to a point of a user's touch input. The guide circle 720 may be connected to a center of the lower end of the screen 700 through dotted lines 740.

As illustrated in FIG. 7C, when the user drags the screen 700 upward by a predetermined distance or more, the locked state of the electronic device may be released to display a home screen. In descriptions related to FIG. 7, upper and lower ends may be exchangeable with each other, such that the dotted line 740 or 750 may extend from either a top or bottom distal end of the screen.

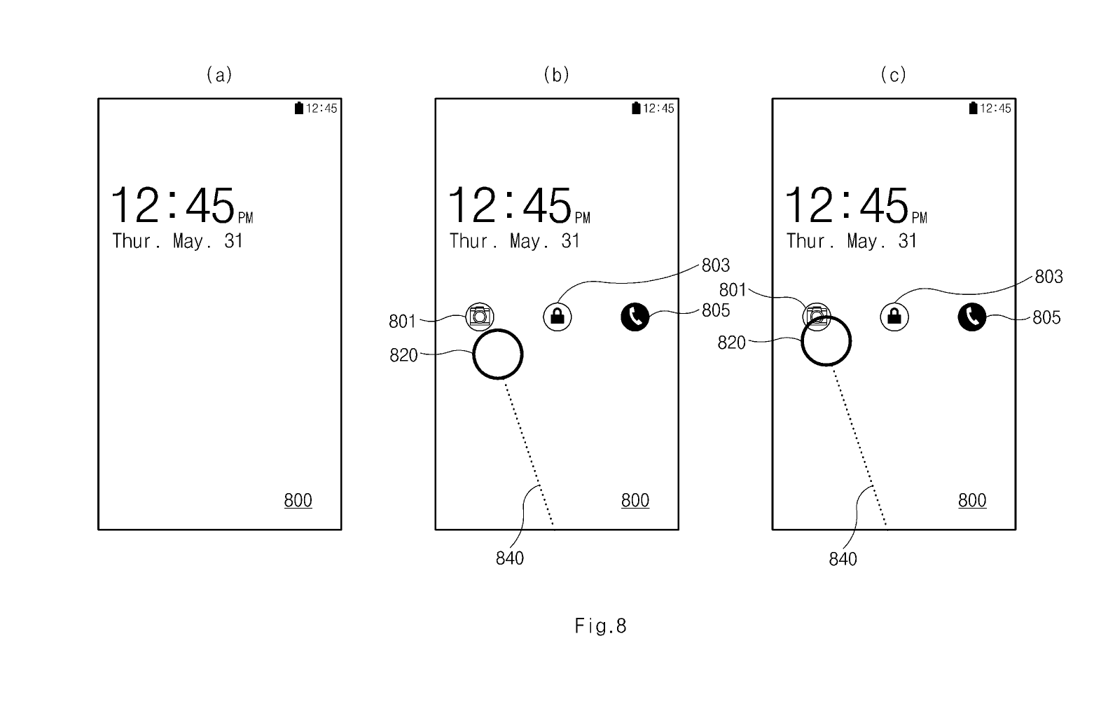

FIG. 8 is a view of a screen for unlocking according to a modified embodiment of the present disclosure.

FIG. 8A illustrates a screen 800 of an electronic device that is in a locked state. When a user drags the screen 800 of the electronic device upward from a lower end of the screen 800, as illustrated in FIG. 8B, a guide circle 820 may be displayed corresponding to a point that is touched at present by the user. The guide circle 820 may be connected to a center of the lower end of the screen 800 through dotted lines 840. Also, icons 801, 803 and 805 that represent events executed together with the unlocking may also be displayed. For example, an icon 801 may represent a camera application, an icon 803 may represent simple unlocking, and an icon 805 may represent a call application.

As illustrated in FIG. 8C, when the user drags the guide circle 820 upward by a predetermined distance or more to allow the touch point to be disposed on an unlocking icon 830, the locked state of the electronic device may be released. In this case, it may be configured to stay for a predetermined time or more on an area corresponding to the specific icon. As illustrated in the drawings, when the locked state is released in a state where the guide circle 820 is disposed on the icon 801, a camera application may be executed together with the unlocking. In descriptions related to FIG. 8, upper and lower ends may again be exchangeable with each other.

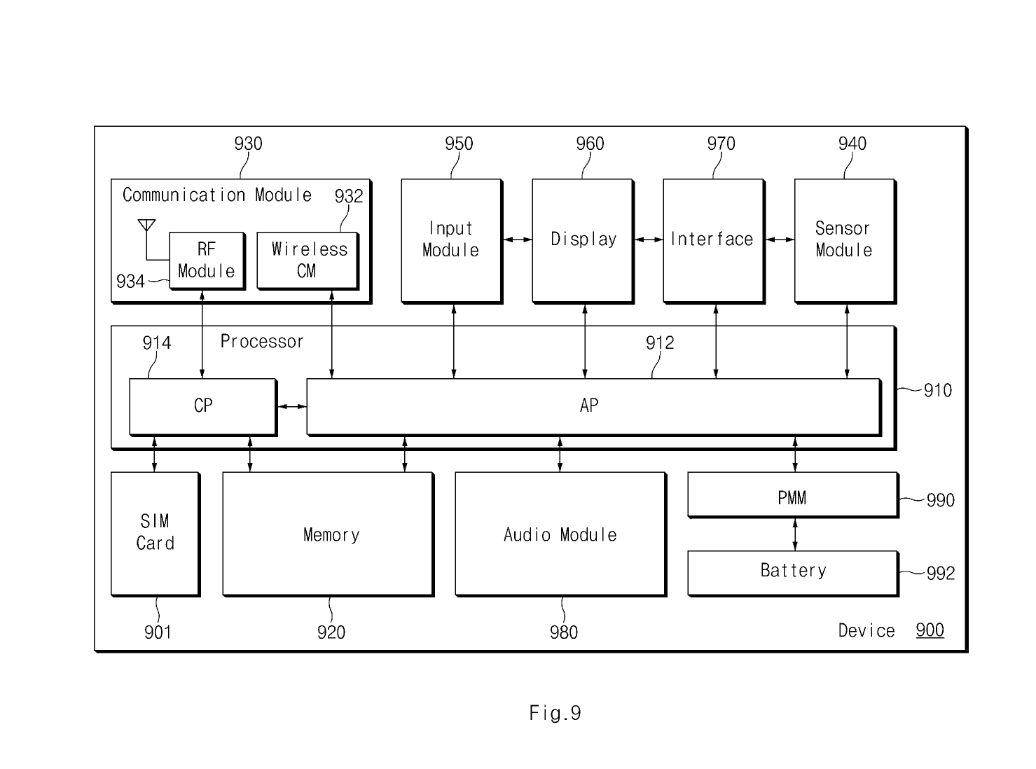

FIG. 9 is a view of an example structure of an electronic device that supports an unlocking effect according to an embodiment of the present disclosure.

Referring to FIG. 9, an electronic device 900 may include a processor 910, a memory 920, a communication module 930, a sensor module 940, an input module 950, a display 960, an interface 970, an audio module 980, a power management module (PMM) 990, a battery 992, and an SIM card 901.

The processor 910 may include at least one application (AP) 912 and/or at least one communication processor (CP) 914. Although the processor 910 includes the AP 912 and the CP 914 in FIG. 9, the AP 912 and the CP 914 may be respectively provided in IC packages different from each other. According to an embodiment, the AP 912 and the CP 914 may be provided in one IC package.

An operating system or application program may operate by the AP 912 to control a plurality of hardware or software elements connected to the AP 912 and process or calculate various data including multimedia data. For example, the AP 912 may be realized as a system on chip (SoC). According to an embodiment, the processor 910 may further include a graphic processing unit.

The CP 914 may manage a data link in communication between the electronic device 900 and other electronic devices that are connected to the electronic device 900 through network and convert a communication protocol. The CP 914 may be realized as a SoC. In an embodiment, the CP 914 may perform at least one portion of multimedia control functions. For example, the CP 914 may distinguish and identify electronic devices in the communication network by using a subscriber identity module (e.g., the SIM card 901). Also, the CP 914 may provide services such as voice call, video call, text messages, or packet data to a user.

Also, the CP 914 may control data transmission/reception of the communication module 930. Although the elements such as the CP 914, the PMM 990, and the memory 920 are separated from the AP 912 in FIG. 9, the present disclosure is not limited thereto. According to an embodiment, the AP 912 may include at least one portion (e.g., the CP 914) of the foregoing elements.

According to an embodiment, the AP 912 or the CP 914 may load a command or data received from at least one of a nonvolatile memory that is connected to each of the AP 912 and the CP 914 or other elements to a volatile memory. Also, the AP 912 or the CP 914 may store data received from at least one of other elements or data generated by at least one of other elements in the nonvolatile memory.

The SIM card 901 may be a card including the subscriber identity module. Also, the SIM card 901 may be inserted into a slot formed in a specific position of the electronic device. The SIM card 901 may include an integrated circuit card identifier (ICCID) or an international mobile subscriber identity (IMSI).

The memory 920 may include an internal memory and/or an external memory. The internal memory may include at least one of volatile memories such as a DRAM, an SRAM, and an SDRAM or nonvolatile memories such as an one time programmable ROM (OTPROM), a PROM, an EPROM, an EEPROM, a mask ROM, a flash ROM, an NAND flash memory and a NOR flash memory. According to an embodiment, the internal memory may be an SSD. The external memory may further include a flash driver such as a compact flash (CF) card, an SD card, a micro-SD card, a mini-SD card, an Xd card, or a memory stick. The external memory may be functionally connected to the electronic device 900 through various interfaces. According to another embodiment, the electronic device 900 may further include a storage device (or a storage medium) such as an HDD.

The communication module 930 may include a wireless communication module 932 and/or an RF module 934. For example, the wireless communication module 932 may include Wi-Fi, Bluetooth, GPS, or NFC. The wireless communication module 932 may provide a wireless communication function by using an RF frequency. Also, the wireless communication module 932 may include a network interface (e.g., an LAN card) or modem for connecting the electronic device 900 to a network (e.g., Internet, LAN, WAN, telecommunication network, cellular network, and satellite network) or plain old telephone service (POTS).

The RF module 934 may perform data communication such as transmission/reception of an RF signal. For example, the RF module 934 may include a transceiver, a power amp module (PAM), a frequency filter, or a low noise amplifier (LNA). Also, the RF module 934 may further include components for transmitting or receiving electromagnetic waves in a free wireless communication space, for example, a conductor or a wire. In an embodiment, an antenna system may correspond to the RF module 934 or constitute at least one portion of the RF module 934.

The sensor module 940 may measure a physical quantity or detect an operation state of the electronic device 900 to convert the measured or detected information into an electrical signal. The sensor module 940 may include at least one of a gesture sensor, a Gyro sensor, a pressure sensor, a magnetic sensor, an accelerometer, a grip sensor, a color sensor (e.g., an RGB sensor), bio-sensor, a temperature/moisture sensor, an illumination sensor, or an ultraviolet (UV) sensor. Also, the sensor module 940 may include an odor sensor, an electromyography (EMG) sensor, an electroencephalogram (EEG) sensor, an electrocardiogram (ECG) sensor, an IR sensor, an iris sensor, or a fingerprint sensor. The sensor module 940 may further include a control circuit for controlling at least one sensor.

The input module 950 may include a touch panel, a (digital) pen sensor, a key or ultrasonic wave input units. For example, the touch panel may recognize a touch input through at least one method of capacitive, resistive, or ultrasonic wave touch methods. Also, the touch panel may include a control circuit. In the capacitive touch method, physical contact or proximity awareness may be enabled. The touch panel may further include a tactile layer. In this case, the touch panel may provide tactile reaction to a user.

The display 960 may include a panel, a hologram, or a projector. For example, the panel may be an LCD or an AM-OLED. Also, the panel may be flexible, transparent, or wearable. The panel may be integrated with the touch panel as one module. The hologram may display a three-dimensional image in air by using light interference. The projector may project light onto a screen to display an image. The screen may be disposed inside or outside the electronic device 900. According to an embodiment, the display 960 may further include a control circuit for controlling the panel, the hologram, or the projector.

The interface 970 may include an HDMI, an USB, an optical communication terminal, or a D-sub terminal. Also, the interface 970 may include a mobile high-definition link (MHL), and SD card/multi-media card (MMC), or an infrared data association (IrDA).

The audio module 980 may bidirectionally convert a sound and an electrical signal into each other. The audio module 980 may process sound information that is inputted or outputted through a speaker, a receiver, an earphone, or a microphone.

The PMM 990 may management a power of the electronic device 900. The PMM 990 may include a power management integrated circuit (PMIC), a charger integrated circuit (IC), or a battery or fuel gauge.

The electronic device that is capable of realizing the various embodiment of the present disclosure may include all or a portion of the above-described elements. For example, the electronic device may include a processor 910 and a touch panel. The touch panel may perform at least one of functions of the input module 950 for receiving a touch input, the display 960 for displaying an image according to a user input, the interface 970, and the sensor module 940 for detecting a capacitive, resistive, or optical input.

The touch panel may receive an input from the user. When the user input on a first point of the touch panel of the electronic device that is in a locked state is detected, a unlock circle that is centered to the first point may be displayed on the touch panel. When a drag input from the first point to a second point is received, the processor may determine whether the drag input satisfies the foregoing unlocking conditions. Then, according to the determined result, the processor may unlock the electronic device or not unlock the electronic device.

Hereinafter, a process according to various embodiments of the present disclosure, which is performed by the electronic device, will be described. In the following descriptions, descriptions overlapping with the above-described descriptions will be omitted.

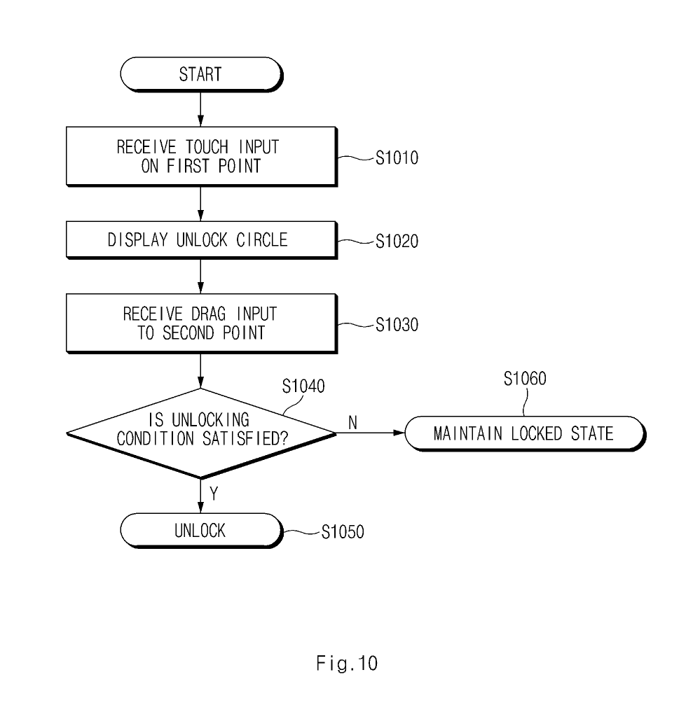

FIG. 10 is a view of an unlocking process of the electronic device according to an embodiment of the present disclosure.

Referring to FIG. 10, in operation S1010, an electronic device receives a touch input on a first point of a screen thereof from a user. In operation S1020, the electronic device may display an unlock circle that is centered to the first point in response to the touch input. In the process related to FIG. 10, the above-described center circle, guide circle, the line connecting the center circle to the guide circle, and text may be displayed together with the unlock circle. In operation S1030, the electronic device may receive a drag input that continuously (i.e., in a state where the touched state is maintained) moves in touch point to a second point of the screen due to the touch input from the user. In operation S1040, the electronic device determines whether the drag input by the user satisfies the specified conditions for unlocking. If the conditions are satisfied, the electronic device may be unlocked in operation S1050. On the other hand, if the conditions are not satisfied, the locked state may be successively maintained in operation S1060.

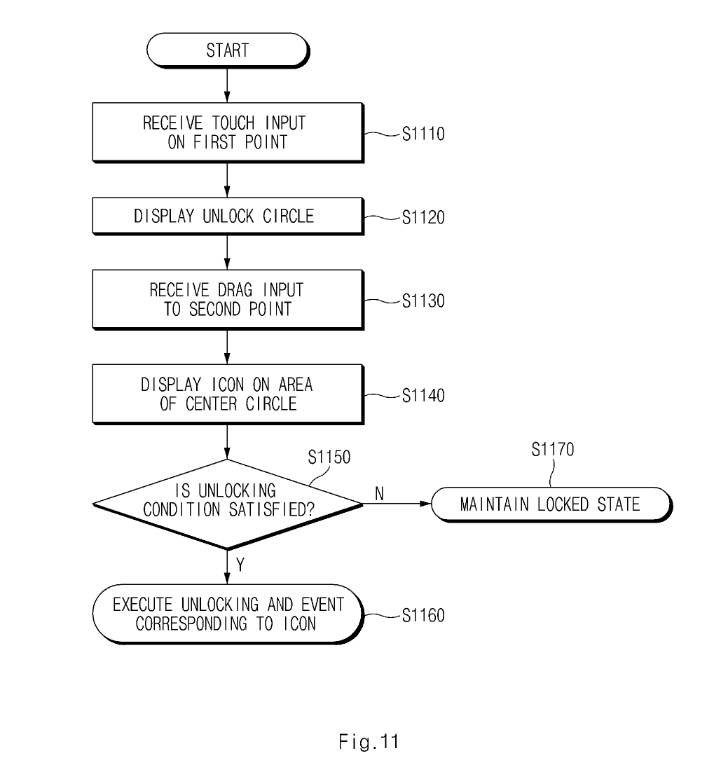

FIG. 11 is a view of an unlocking process of an electronic device according to another embodiment of the present disclosure.

Referring to FIG. 11, in operation S1110, the electronic device receives a touch input on a first point of a screen thereof from a user. In operation S1120, the electronic device may display an unlock circle that is centered to the first point in response to the touch input. In the process related to FIG. 11, the above-described center circle, guide circle, the line connecting the center circle to the guide circle, and text may be displayed together with the unlock circle. In operation S1130, the electronic device may receive a drag input that continuously (i.e., in a state where the touched state is maintained) moves in touch point to a second point of the screen due to the touch input from the user. In operation S1140, the electronic device may display an icon that represents an event set to execute when the electronic device is unlocked on an area of a center circle. The icon may change according to a position of the second point. For example, when a simple unlock event icon is displayed on the area of the center circle, if the second point changes in position upward at an angle of about 30 degrees outside the unlock circle, the event icon on the area of the center circle may change into a camera icon. On the other hand, if the second point changes in position downward at an angle of about 30 degrees, the event icon on the area of the center circle may change into a text message icon. The angle may represent an angle between a connection line connecting a guide circle to the center circle and a reference line (e.g., a connection line at a time point at which an initial icon is displayed, or a virtual X-axis using the center circle as a starting point).

In operation S1150, the electronic device determines whether the drag input by the user satisfies the specified conditions for unlocking. If the conditions are satisfied, the electronic device may be unlocked to execute an event corresponding to the icon displayed on the area of the center circle in operation S1160. If the conditions are not satisfied, the locked state may be successively maintained in operation S1170.

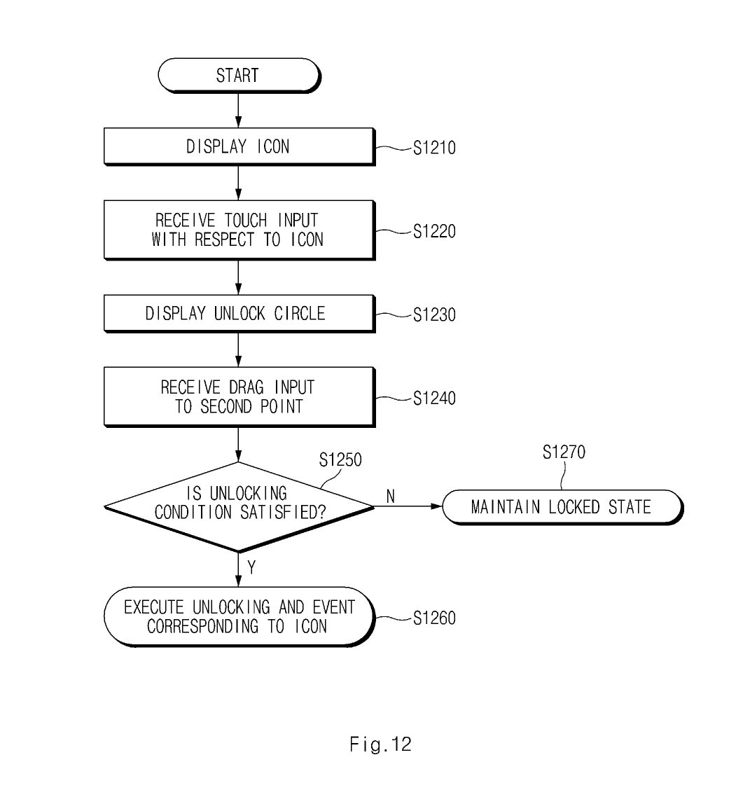

FIG. 12 is a view of an unlocking process of an electronic device according to another embodiment of the present disclosure.

In operation S1210, the electronic device displays at least one icon on a serene of the electronic device that is in a locked state. The icons may represent a missed call that is not recognized or confirmed by a user. In operation S1220, the electronic device may receive a touch input on one icon from the user. The touch input on the icon may be understood as a touch input on a first point in FIGS. 10 and 11.

In operation S1230, the electronic device may display an unlock circle that is centered to the icon in response to the touch input. In operation S1240, the electronic device may receive a drag input that continuously (i.e., in a state where the touched state is maintained) moves in touch point to a second point of the screen due to the touch input from the user.

In operation S1250, the electronic device determines whether the drag input by the user satisfies the specified conditions for unlocking. If the conditions are satisfied, the electronic device may be unlocked to execute an event corresponding to an initial selected icon in operation S1260. If the conditions are not satisfied, the locked state may be successively maintained in operation S1270.

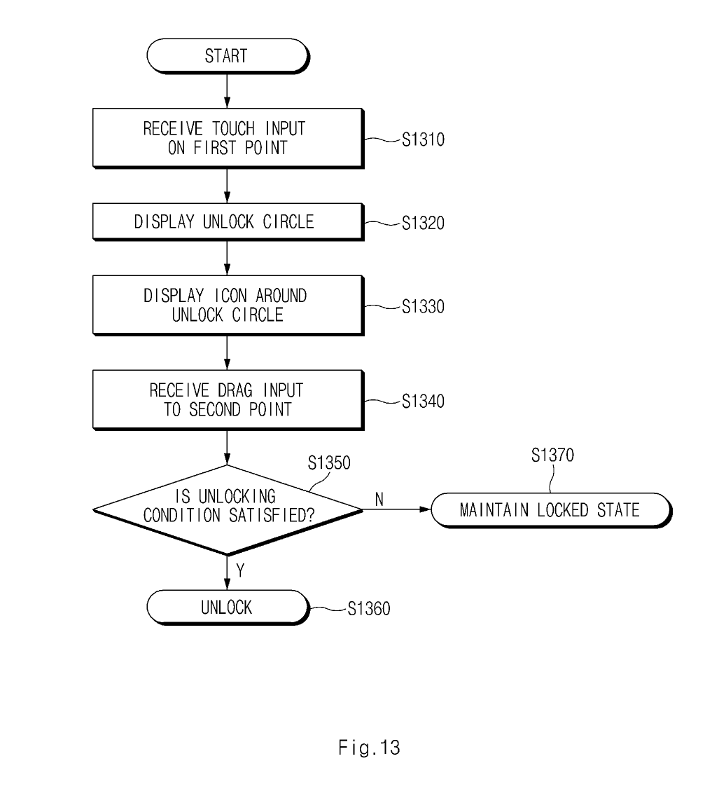

FIG. 13 is a view of an unlocking process of an electronic device according to another embodiment of the present disclosure.

Referring to FIG. 13, in operation S1310, the electronic device receives a touch input on a first point of a screen thereof from a user. In operation S1320, the electronic device may display an unlock circle that is centered to the first point in response to the touch input. In operation S1330, the electronic device may display at least one icon on a position adjacent to a boundary area of an unlock circle. Each of icons may be arranged so that boundaries of the icons and a boundary of the unlock circle are in contact with each other or partially overlap with each other. In operation S1340, the electronic device may receive a drag input that continuously moves in touch point to a second point of the screen due to the touch input from the user. In operation S1350, the electronic device determines whether the drag input by the user satisfies the specified conditions for unlocking. If the conditions are satisfied, the electronic device may be unlocked to execute an event corresponding to a selected icon in operation S1360. If the conditions are not satisfied, the locked state may be successively maintained in operation S1370.

According to various embodiments, although an object having a circle shape is displayed on the screen of the electronic device in regard to the unlocking in the above-described descriptions, the present disclosure is not limited thereto. For example, the object (at least one of the unlock circle, the center circle, or the guide circle) related to the unlocking may have a polygonal shape having a plurality of angles such as a triangular shape, a pentagonal shape, a rectangular shape, a hexagonal shape, an octagonal shape, and the like. Alternatively, the object related to the unlocking may have an oval shape. Also, a functional icon such as the missed call icon may have a polygonal or oval shape.

While this invention has been particularly shown and described with reference to embodiments thereof, it will be understood by those skilled in the art that various changes in form and details may be made therein without departing from the ambit of the invention as defined by the appended claims. Therefore, the embodiments should be considered in descriptive sense only and not for purposes of limitation. Therefore, the ambit of the invention is defined not by the detailed description of the invention but by the appended claims, and all differences within the ambit will be construed as being included in the present disclosure.

According to the various embodiments of the present disclosure, the various embodiments may provide the tension effects for unlocking the electronic device. Also, according to the various embodiments, the event that is executed together with the unlocking may be selectable to prevent undesired unlocking or event execution from occurring.

The above embodiments of the present disclosure are illustrative and not limitative. Various alternatives and equivalents are possible. The invention is not limited by the type of deposition, etching polishing, and patterning steps describe herein. Nor is the invention limited to any specific type of semiconductor device. For example, the present disclosure may be implemented in a dynamic random access memory (DRAM) device or non volatile memory device. Other additions, subtractions, or modifications are obvious in view of the present disclosure and are intended to fall within the ambit of the appended claims.

What is claimed is:

1. A method for unlocking an electronic device, the method comprising:
receiving a touch input on a first point of a screen of the electronic device in a locked state;
displaying an unlock graphic enclosing the first point in response to the touch input;
receiving a drag input to a second point of the screen; and
unlocking the locked state of the electronic device when the drag input satisfies a specified condition.

2. The method according to claim 1, wherein the specified condition comprises at least one of:
a condition in which the drag input is maintained for a predetermined time outside the unlock graphic, and
a condition in which the second point is disposed at a point that is spaced a predetermined distance outward from a boundary of the unlock graphic.

3. The method according to claim 1, wherein, when the second point is disposed inside the unlock graphic, the electronic device is maintained in the locked state.

4. The method according to claim 1, wherein a boundary of the unlock graphic is adjusted in transparency according to a distance between the second point and the boundary.

5. The method according to claim 1, further comprising, when the locked state is released, allowing the unlock graphic to increase in transparency until the unlock graphic is not displayed.

6. The method according to claim 1, further comprising displaying a center graphic defining the first point and a guide graphic that moves according to the touch input in tandem with the unlock graphic,
wherein the center graphic and the guide graphic are displayed connected to each other by a graphic line simulating tension between the center graphic and the guide graphic.

7. The method according to claim 6, wherein the guide graphic is disposed on a point corresponding to the touch input when the second point is disposed inside the unlock graphic, and when the second point is disposed outside the unlock graphic, the guide graphic contacts a portion of a boundary of the unlock graphic.

8. The method according to claim 6, wherein, when the specified condition is satisfied, the graphic line is displayed as being broken.

9. The method according to claim 8, wherein, when the graphic line is broken, the guide graphic is separated from a boundary of the unlock graphic and is moved towards the second point.

10. The method according to claim 9, wherein the center graphic is moved in a direction opposite to the moving direction of the guide graphic.

11. The method according to claim 6, further comprising displaying an icon that represents an event to be executed on at least a portion of the center graphic, wherein, when the electronic device is unlocked, the event is executed.

12. The method according to claim 11, wherein the icon is changed to indicate a different event to be executed according to changes of a position of the guide graphic.

13. The method according to claim 1, wherein the displaying of the unlock graphic comprises displaying at least one icon indicating an event to be executed on an area outside the unlock graphic, and
wherein when the second point corresponds in position on an icon of the at least one icon, then the event corresponding to the icon is executed when the locked state is released.

14. The method according to claim 1, further comprising displaying at least one icon indicating an event to be executed, wherein when the first point corresponds in position to the at least one icon, then the event corresponding to the icon is executed when the locked state is released.

15. An electronic device having a tension effect for unlocking, the electronic device comprising:
a touch panel; and
a processor configured to:
when a touch input on a first point of the touch panel is received, display an unlock circle centered to the first point on the touch panel, and
when a drag input is received following the touch input, release a locked state of the electronic device when the drag input satisfies a pre-specified condition.

16. The electronic device according to claim 15, wherein the touch panel is further configured to display:
a center circle defining the first point,
a guide circle configured to move according to the touch input, and
a connection object visually connecting the center circle to the guide circle.

17. The electronic device according to claim 16, wherein the processor is further configured to display on the touch panel the connection object being visually broken when the pre-specified condition is satisfied.

18. The electronic device according to claim 17, wherein the processor is further configured to display on the touch panel the guide circle being separated from a boundary of the unlock circle to move to a second point when the connection object is visually broken.

19. The electronic device according to claim 16, wherein the processor is further configured to display on the touch panel an icon that represents an event to be executed upon release of the lock state, and execute the event when the lock state is released.

20. The electronic device according to claim 16, wherein the processor is further configured to display on the touch panel an icon that represents an event to be executed upon release of the lock state, and alter the icon to display different events to be executed according to a position of the guide circle.
